(19) United States
(12) Patent Application Publication
(10) Pub. No.: US 2010/0182214 A1
(43) Pub. Date: Jul. 22, 2010

(54) Variable Directional Antenna

(75) Inventors: Atsushi HONDA, Kawasaki (JP); Ichirou IDA, Kawasaki (JP); Yasuyuki OISHI, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki-shi (JP)

(21) Appl. No.: 12/698,703

(22) Filed: Feb. 2, 2010

Related U.S. Application Data
(63) Continuation of application No. PCT/JP2007/000860, filed on Aug. 9, 2007.

(51) Int. Cl. H01Q 3/34; H01Q 19/10

(52) U.S. Cl. 343/834

(57) ABSTRACT

A variable directional antenna by means of a microstrip antenna and reactance change. The variable directional antenna has a structure to reduce sidelobes occurring when an element interval is reduced, and is structured in a three-element plane, having a feeding element and non-feeding elements provided at both sides of the feeding element. Each of the non-feeding elements provided at both sides of the feeding element has two split non-feeding elements two-divided into sizes of 1:2 in the lateral direction. The split non-feeding element divided into the size 1 is provided closer to the feeding element, and a reactance variable part is connected with the split non-feeding element divided into the size of 2. Alternatively, each of the non-feeding elements provided at both sides of the feeding element has two split non-feeding elements two-divided into sizes of 2:1 in the lateral direction. The split non-feeding element divided into the size 2 is provided closer to the feeding element, and the reactance variable part is connected either with the split non-feeding element divided into the size of 2 or the split non-feeding element divided into the size 1.

### CROSS-REFERENCE TO RELATED APPLICATIONS

This application is a continuation of International Application No. PCT/JP2007/860, filed on Aug. 9, 2007, now pending, herein incorporated by reference.

### FIELD

The present invention relates to a variable directional antenna which is based on the reactance change and uses a micro strip antenna.

### BACKGROUND

As an antenna for a wireless terminal, a variable directional antenna, that is an array antenna and yet has antenna directivity that can be changed using one feed element and a parasitic element having a variable capacitance element, has been proposed.

An example thereof is the ESPAR (Electrical Steerable Parasitic Array Radiator) antenna, which can change the directivity of the antenna by changing the reactance value of the parasitic element. This type of antenna has an advantage in terms of cost and power consumption, since a number of receivers can be few, compared with a digital processing type array antenna, which has a receiver for each antenna element.

A conventional ESPAR antenna, however, uses a seven-element mono-pole antenna, as depicted in Patent Document 1.

FIG. 1 is a diagram depicting the configuration depicted in Patent Document 1. A radiative element 2 is disposed at the center of a finite reflector 1 that has a skirt portion 11. A plurality of parasitic elements 3 are disposed around the radiative element 2.

It is not easy to apply this configuration directly to a terminal. In order to make this configuration flat, an example of the ESPAR antenna constituted by a three-element dipole antenna was proposed. A flat type beam shaping antenna using a micro strip antenna was also proposed because of ease of manufacture.

FIG. 2 is a diagram depicting a configuration of a flat type beam shaping antenna using this micro strip antenna (Non-patent Document 1).

In the case of the micro strip antenna depicted in Non-patent Document 1, the coupling between antennas becomes weaker when an array antenna configuration is used, so it is difficult to change the directivity of the antenna unless the degree of coupling is secured by decreasing the space between the elements.

If the space between the antenna elements is decreased, however, the degree of coupling is maintained, but the aperture plane of the array decreases and the side lobe become bigger. If the side lobe becomes bigger in the array antenna, interference suppression capability drops and interference increases.

### Patent Document 1: Japanese Patent No. 349723

Non-patent Document 1: 2002 General Conference of IEICE: “Shaped beam micro strip array antenna”

### SUMMARY

With the foregoing in view, it is an object of the present invention to provide a variable directional antenna, based on the reactance change and using a micro strip antenna, that has a configuration to decrease the side lobe that generates when the element space is decreased.

A variable directional antenna of the first aspect according to the present invention realizing the above object is a variable directional antenna with a three-element plane configuration, having a feed element and parasitic elements disposed on both sides of the feed element, comprising: each of the parasitic elements disposed on both sides of the feed element including two divided parasitic elements, of which sizes are at a ratio of 1:2 in the lateral direction, wherein the divided parasitic element having the size of 1 is disposed at the side closer to the feed element, and a reactance variable portion is connected to the divided parasitic element having the size of 2.

A variable directional antenna of the first aspect according to the present invention realizing the above object is a variable directional antenna with a three-element plane configuration, having a feed element and parasitic elements disposed on both sides of the feed element, comprising: each of the parasitic elements disposed on both sides of the feed element including two divided parasitic elements, of which sizes are at a ratio of 2:1 in the lateral direction, wherein the divided parasitic element having the size of 2 is disposed at the side closer to the feed element, and a reactance variable portion is connected to one of the divided parasitic elements having the size of 2 and the divided parasitic element having the size of 1.

In the above characteristics, the two divided parasitic elements may be connected to each other with a micro strip line.

Further, the reactance variable portion can be formed on a same surface as that of a substrate, on which the feed element and the parasitic elements disposed on both sides of the feed element are formed, and the reactance variable portion and the parasitic element are connected with a micro strip line formed on the surface of the substrate.

Also, the micro strip line is branched, and the reactance variable portion is connected to the two divided parasitic elements.

Because of the characteristics of the present invention, the side lobe, that generates when the element space is decreased, can be decreased in a variable directional antenna based on the reactance change using the micro strip antenna.

### BRIEF DESCRIPTION OF DRAWINGS

FIG. 1 is a diagram depicting the configuration depicted in Patent Document 1.

FIG. 2 is a diagram depicting a configuration of a flat type beam shaping antenna using this micro strip antenna.

FIG. 3 is a diagram depicting the configuration of a flat type three-element variable directional antenna as a comparison example, and only an antenna pattern of the three elements.

FIG. 4 is a perspective view depicting the configuration of a flat type three-element variable directional antenna as a comparison example.

FIG. 5 depicts a directivity pattern of the antenna according to the comparison example of FIG. 4.

FIG. 6 depicts a configuration of an element pattern of the variable directional antenna according to a first embodiment of the present invention.

FIG. 7 depicts a configuration of an element pattern of the variable directional antenna according to a second embodiment of the present invention.

FIG. 8 depicts the directivity patterns of the first embodiment and second embodiment.

FIG. 9 depicts a configuration of an element pattern of the variable directional antenna according to a third embodiment of the present invention.

FIG. 10 depicts the directivity pattern of the third embodiment.

FIG. 11 depicts a configuration of an element pattern of the variable directional antenna according to a fourth embodiment.

FIG. 12 depicts the directivity pattern of the fourth embodiment.

FIG. 13 is a second comparison example when a reactance circuit portion, that is connected to the parasitic element depicted in FIG. 3, is created on a same surface as the substrate where the pattern of a feed element and a parasitic element is formed.

FIG. 14 depicts a configuration of an element pattern of the variable directional antenna according to a fifth embodiment.

FIG. 15 depicts a configuration of an element pattern of the variable directional antenna according to a sixth embodiment.

FIG. 16 depicts the directivity patterns of the fifth embodiment and sixth embodiment in comparison with the second comparison example.

FIG. 17 depicts a configuration of an element pattern of the variable directional antenna according to a seventh embodiment.

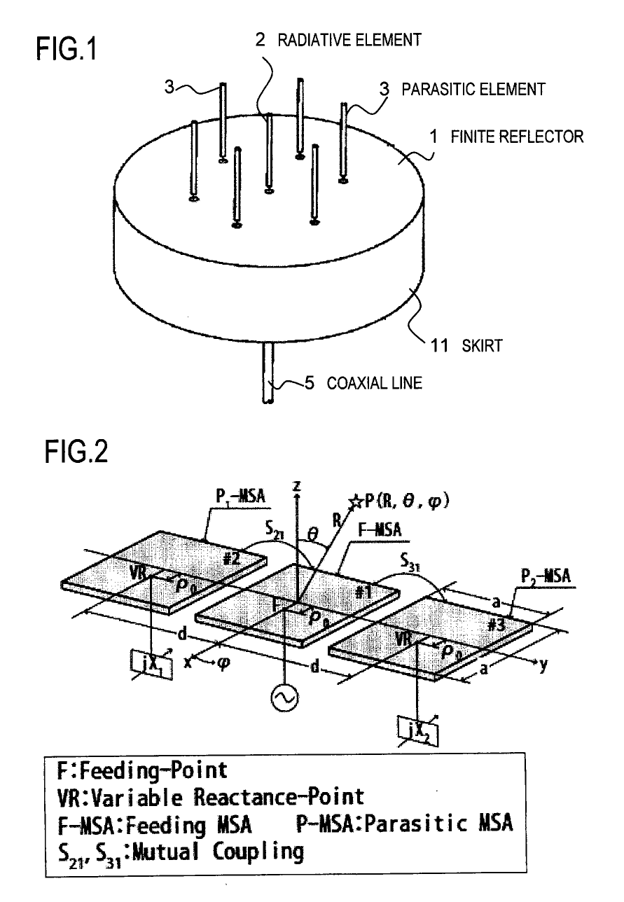

### DESCRIPTION OF DRAWINGS

A configuration of an embodiment of the present invention will now be described with reference to the drawings, but in order to assist understanding the configuration and the effect of the variable directional antenna according to the present invention, a comparison example created by the present inventor, similar to the configuration depicted in Non-patent Document 1, will be described first.

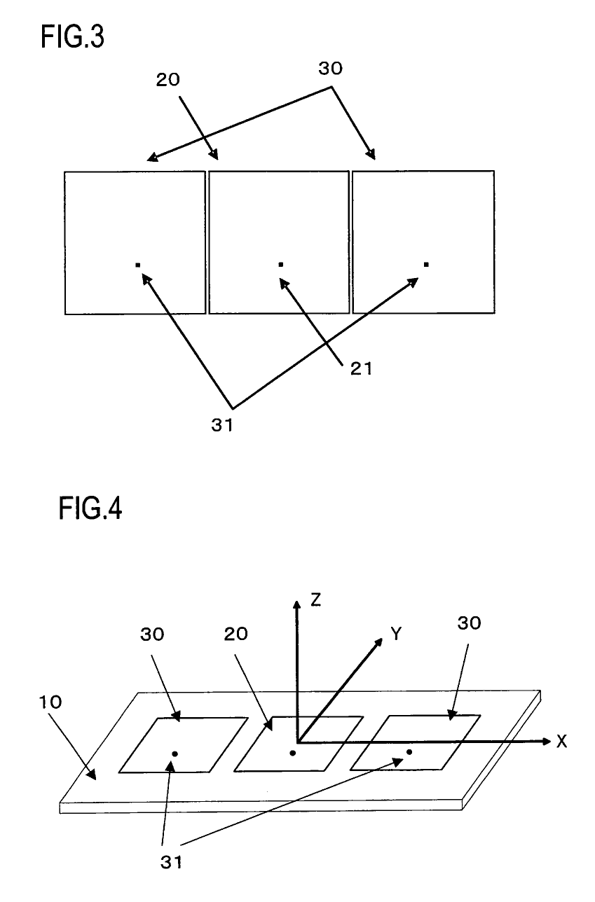

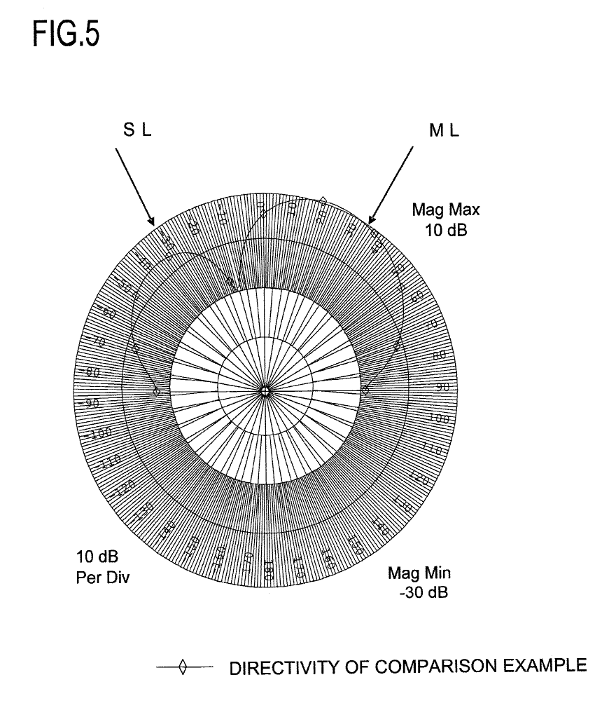

FIG. 3 and FIG. 4 are diagrams depicting the configuration of a flat type three-element variable directional antenna as a comparison example. In FIG. 3, only an antenna pattern of the three elements is depicted, and FIG. 4 is a perspective view of the variable directional antenna in which the antenna pattern of the three elements is formed on an insulating substrate.

The antenna pattern of the three elements is formed on the insulating substrate 10. The antenna element at the center is a feed element 20, and the antenna elements at the left and right are parasitic elements 30. A feed portion and a reactance variable circuit portion, which are not illustrated, are connected to the port portions 21 and 31 of each antenna element.

In the configuration depicted in FIG. 3 and FIG. 4, the feed portion connected to the port portion 21 is a coaxial feed type. In a reactance variable circuit portion of the parasitic element connected to the port portion 31, a variable capacitance element (e.g. varactor diode, MEMS variable capacitor) is connected to a coaxial line.

The reactance value can be changed in the 0Ω to −100Ω range, for example, using this variable capacitance element, and the directivity of the antenna can be changed by setting the reactance value to an appropriate value.

Here the reactance value of the parasitic element at the left and right are set to 0Ω to −100Ω. The antenna element space of the three elements is 0.4λ according to Non-patent Document 1, but 0.3λ is used here in order to test with a smaller antenna element space.

FIG. 5 depicts a directivity pattern of the antenna according to this comparison example. The directivity pattern is one plotted on the ZX plane based on the coordinate axes depicted in FIG. 4. The directivity is inclined from the Z direction toward the X axis, which depicts the directivity change. It also depicts that side lobe SL increased as well as the main lobe ML.

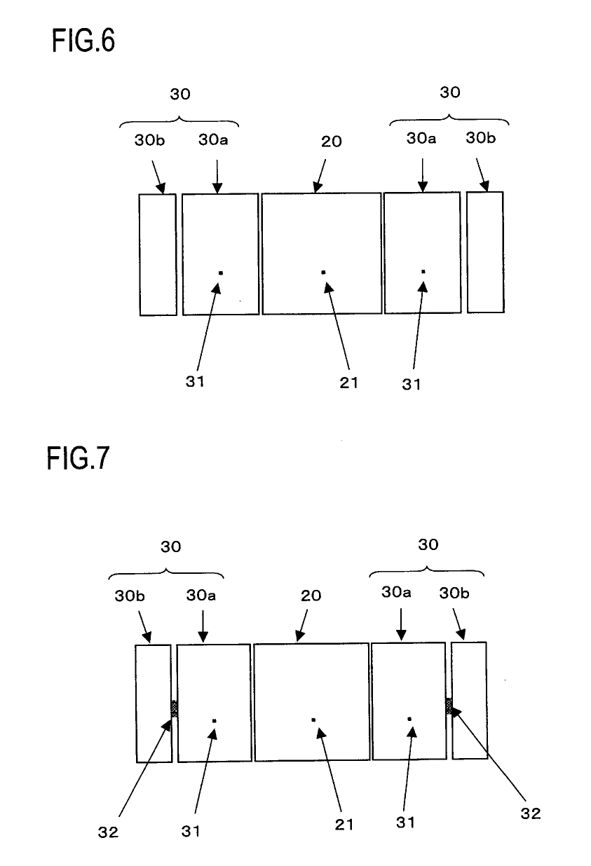

While the above is a comparison example, FIG. 6 depicts a configuration of an element pattern of the variable directional antenna according to a first embodiment of the present invention.

As FIG. 6 depicts, in the variable directional antenna of the comparison example depicted in FIG. 3, the respective lateral length of the parasitic elements 30 disposed on both sides of the feed element 20 is divided at 2:1, so as to be two divided parasitic elements 30a and 30b. In this configuration, the reactance variable portion is connected to a port 31 of the divided parasitic element 30a, which is located closer to the feed element 20.

In this configuration, the phase of current, that is supplied to the feed element 20, is adjusted by adjusting the reactance of the reactance variable portion, and current also flows into the parasitic elements 30b, thereby an aperture of the antenna can be increased and as a result the side lobe SL can be decreased.

FIG. 7 depicts a configuration of an element pattern of the variable directional antenna according to a second embodiment of the present invention.

In the configuration of the second embodiment, a fine micro strip line 32 connects the two parasitic elements 30a and 30b divided in the first embodiment. The flow of the current in the parasitic element 30b can be increased by the micro strip line 32.

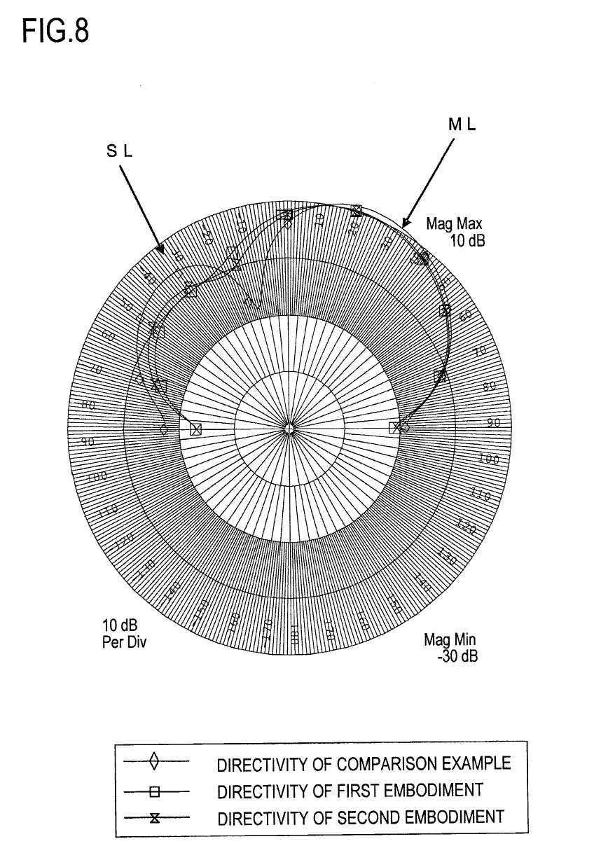

FIG. 8 depicts the directivity patterns of the first embodiment and second embodiment. Compared with the directivity pattern of the comparison example, the side lobe SL is decreased in the first embodiment and second embodiment. The frequency used here is 5.06 GHz.

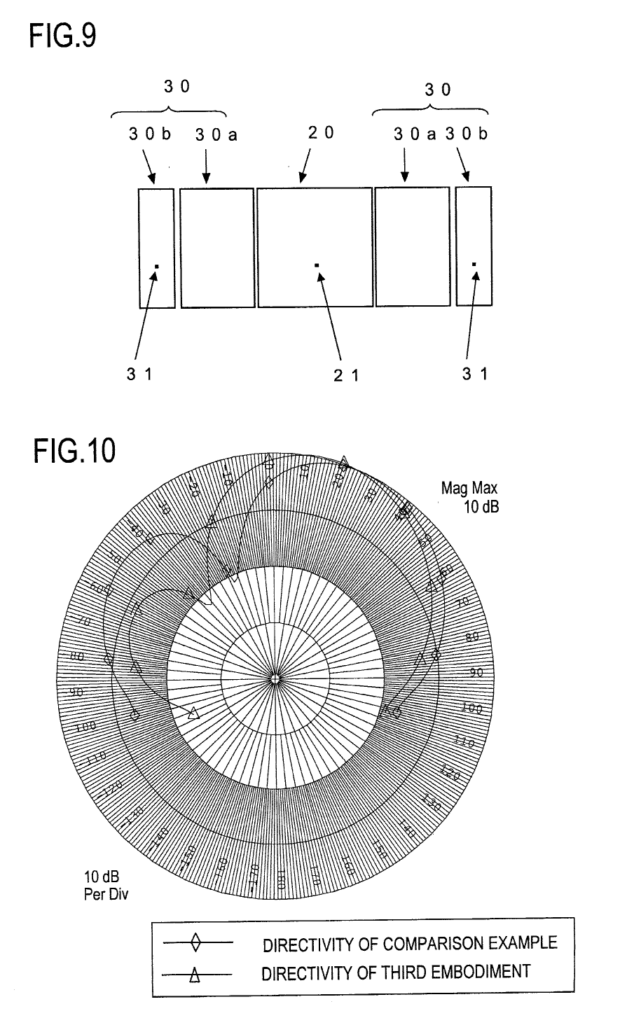

FIG. 9 depicts a configuration of an element pattern of the variable directional antenna according to a third embodiment of the present invention.

In the configuration of the third embodiment, a reactance variable portion is connected to a port 31 of the divided parasitic element 30b, which is located further away from the feed element 20, of the parasitic elements 30a and 30b, which are divided at a 2:1 ratio in the lateral length.

FIG. 10 depicts the directivity pattern of the third embodiment. Compared with the comparison example and the first and second embodiments in FIG. 8, the side lobe SL is further decreased.

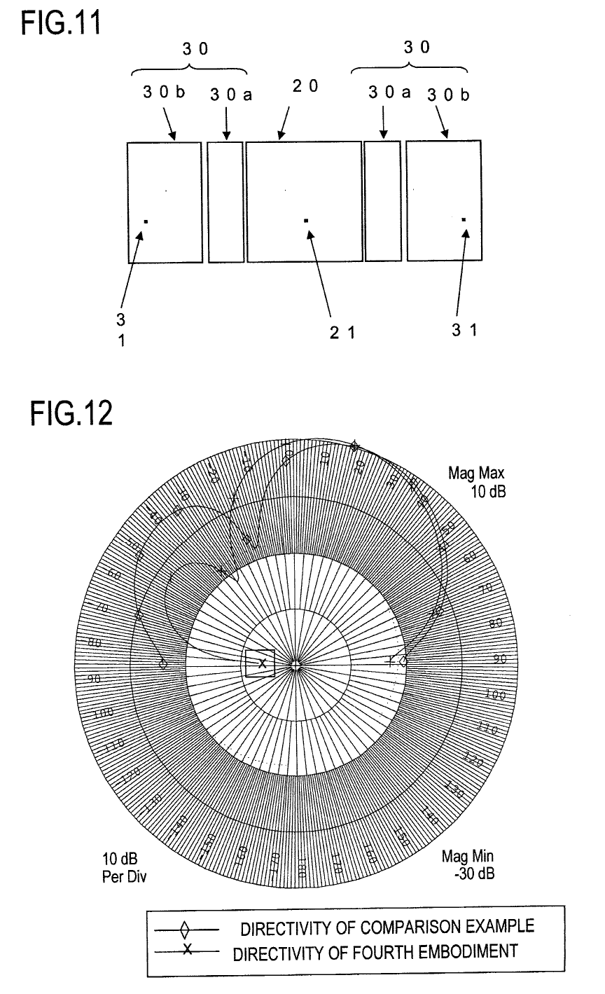

FIG. 11 depicts a configuration of a fourth embodiment in which a reactance variable portion is connected to a parasitic element 30b, which is located outside, of the parasitic elements 30a and 30b that are obtained by dividing the parasitic element 30 at a 1:2 ratio in the lateral length.

FIG. 12 depicts the directivity pattern of the fourth embodiment. In this case as well, it is clear that the side lobe SL can be decreased.

According to simulations thus far, as the third and fourth embodiments depict, the side lobe SL can be decreased more if the reactance variable portion is connected to the divided parasitic element 30b located outside, that is the side further away from the parasitic element 20, than the divided parasitic element 30a located inside, that is the side closer to the parasitic element 20.

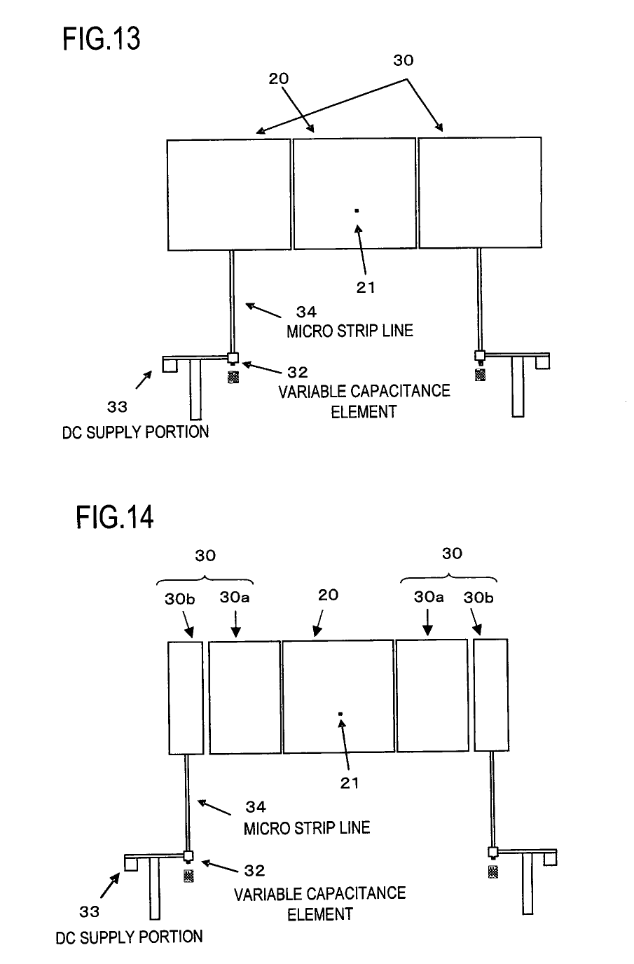

One reason for this is that the divided parasitic element 30b outside can more easily secure the required distance between antennas.

Where FIG. 3 is a comparison example pattern of the feed element 20 and parasitic elements 30, FIG. 13 is a second comparison example when a reactance circuit portion, that is connected to the parasitic element 30, is created on a same surface as the substrate where the pattern of the feed element 20 and the parasitic element 30 is formed.

The antenna element portion of the parasitic element 30 and the reactance circuit portion are constituted by a variable capacitance element 32, a DC bias voltage supply portion 33, and a micro strip line 34 with a length of ¼λ.

Just like the coaxial feed type in the previous embodiments, the reactance value changes and directivity of the entire antenna changes by changing the capacity value of the variable capacitance element 32 according to the DC bias voltage of the bias voltage supply portion 33.

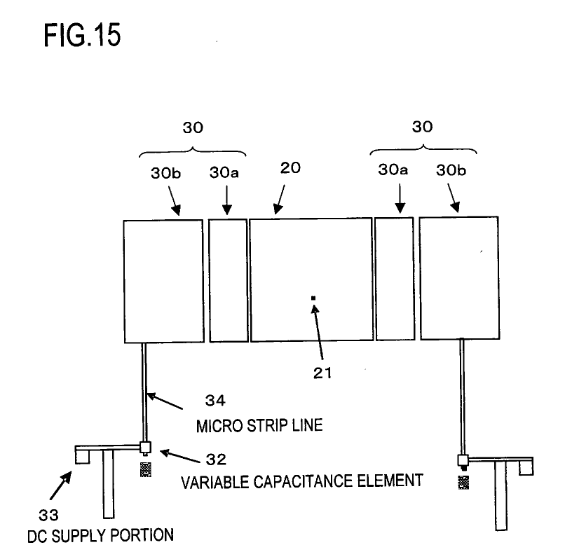

While the above is the second comparison example, a fifth embodiment (FIG. 14) and a sixth embodiment (FIG. 15) have a configuration where a pattern of the parasitic element 30 is divided into the divided parasitic elements 30a and 30b, just like the first embodiment (FIG. 6) and the second embodiment (FIG. 9) respectively.

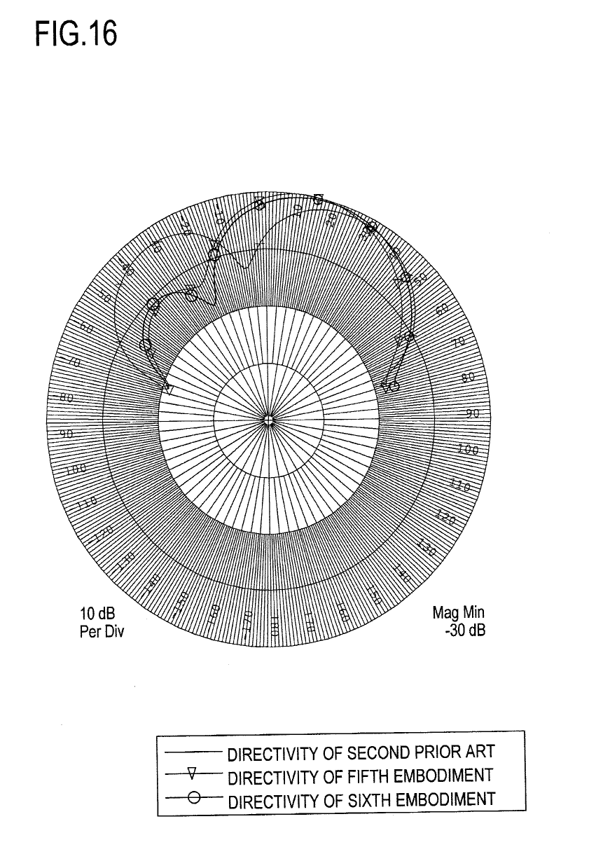

FIG. 16 depicts the directivity patterns of the fifth embodiment and sixth embodiment in comparison with the second comparison example. As FIG. 16 depicts, a side lobe can be decreased by also disposing the reactance circuit portion on the surface of the substrate.

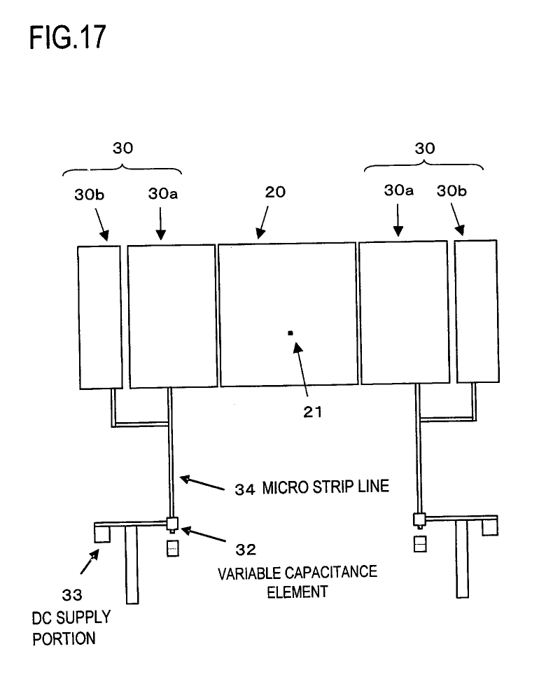

FIG. 17 depicts a seventh embodiment, that is a variable directional antenna in which the configuration in FIG. 15 has been improved. In this configuration, the micro strip line 34 is branched and connected to the divided parasitic elements 10a and 30b in parallel. Thereby the reactance component of the variable capacitance element 32 is supplied, and the divided parasitic element 30b, that is the side further away from the parasitic element 20, can be strongly excited. As a result, it can be expected that strong directivity is implemented.

### INDUSTRIAL APPLICABILITY

By the above mentioned configuration of the present invention, the element outer side is strongly excited at a different phase, and the aperture plane of the array antenna can be increased while maintaining the coupling between elements. As a result, the side lobe, that is generated when the directivity is controlled, can be decreased. The configuration of the variable directional antenna according to the present invention, which is constructed by dividing the parasitic elements, can be implemented with a size approximately the same as the prior art.

What is claimed is:

1. A variable directional antenna with a three-element plane configuration, having a feed element and parasitic elements disposed on both sides of the feed element, comprising:
each of the parasitic elements disposed on both sides of the feed element including two divided parasitic elements, of which sizes are at a ratio of 1:2 in the lateral direction, wherein
the divided parasitic element having the size of 1 is disposed at the side closer to the feed element, and a reactance variable portion is connected to the divided parasitic element having the size of 2.

2. A variable directional antenna with a three-element plane configuration, having a feed element and parasitic elements disposed on both sides of the feed element, comprising:
the parasitic elements disposed on both sides of the feed element respectively including two divided parasitic elements, of which sizes are at a ratio of 2:1 in the lateral direction, wherein
the divided parasitic elements having the size of 2 are disposed at the respective sides closer to the feed element, and reactance variable portions are connected to either the divided parasitic elements having the size of 2 or the divided parasitic elements having the size of 1.

3. The variable directional antenna according to claim 1 or claim 2, wherein the two divided parasitic elements are connected to each other with a micro strip line.

4. The variable directional antenna according to any one of claim 1 to claim 3, wherein the reactance variable portion is formed on a surface of a same substrate as a substrate on which the feed element and the parasitic elements disposed on both sides of the feed element are formed, and the reactance variable portion and the parasitic element are connected with a micro strip line formed on the surface of the substrate.

5. The variable directional antenna according to claim 4, wherein the micro strip line is branched, and the reactance variable portion is connected to the two divided parasitic elements.
